(19) United States
(12) Patent Application Publication
(10) Pub. No.: US 2022/0128583 A1
(43) Pub. Date: Apr. 28, 2022

(54) LABORATORY SYSTEM COMPRISING AT LEAST PARTIALLY NETWORKED LABORATORY DEVICES, AND METHOD FOR CONTROLLING A LABORATORY SYSTEM COMPRISING AT LEAST PARTIALLY NETWORKED LABORATORY DEVICES

(71) Applicant: Eppendorf AG, Hamburg (DE)

(72) Inventor: Rainer Treptow, Norderstedt (DE)

(73) Assignee: Eppendorf AG, Hamburg (DE)

(21) Appl. No.: 17/294,046

(22) PCT Filed: Nov. 16, 2018
(86) PCT No.: PCT/EP2018/081538

§ 371 Date: May 14, 2021

(51) Int. Cl. G01N 35/00; G06Q 10/08; G05D 1/10

(52) U.S. Cl. CPC G01N 35/00712; G01N 35/0092; G01N 35/00732; G01N 35/0099; G01N 35/00623; G01N 2035/00633; G05D 1/101; G01N 2035/0096; G01N 2035/00831; G01N 2035/00851; G06Q 10/083

(57) ABSTRACT

The invention relates to a method for controlling a laboratory system comprising at least partially networked laboratory devices for processing samples by means of laboratory processes performed by the laboratory devices, the method comprising:-a process detection step (S1), in which samples to be processed and/or laboratory processes to be performed with the samples are detected via a detection unit (05);-a status determination step (S3), in which a response of networked laboratory devices regarding the current and/or future status and/or the termination of sample processing is obtained by the laboratory devices;-a task update step (S4), in which a task list, at least for the processing of certain samples by means of a certain laboratory device or a plurality of certain laboratory devices in a certain order, is created or updated by a task generation unit at least from the detected samples and/or laboratory processes and/or on the basis of the status of the laboratory devices, in particular by considering predefined prioritisation rules and/or weighting factors;-a management step (S5), in which management instructions are generated and output by a management system on the basis of the current task list, by means of which management instructions detected samples are brought at least indirectly to at least one laboratory device; and-a transport means control step (S6), in which transport means control instructions are generated by a transport means control system on the basis of control instructions and are transmitted to at least one transport means configured as a UAV (unmanned aerial vehicle (04)) at least for the transport of detected samples.

### BACKGROUND OF THE INVENTION

The present invention relates to a method for controlling a laboratory system comprising at least partially networked laboratory devices. Furthermore, the present invention relates to a laboratory system comprising at least partially networked laboratory devices.

Different forms of laboratory systems and methods for controlling laboratory systems are known from the state of the art. In principle, two trends or two main forms have established themselves. Firstly, laboratories or laboratory automatons are known which are as fully automated as possible and in which a high number of laboratory samples is processed by means of a laboratory automaton which is usually configured and set up in a static manner and which is largely self-contained. One of the disadvantages of the known full automated or at least highly automated laboratory systems so far is that said laboratory automatons allow little or no flexibility in the processing of samples. This means that the highly or fully automated laboratory systems are merely intended to perform a few standardized sample processing processes or to execute laboratory processes. Thus, such laboratory systems are only suitable and can only be operated economically if a particularly high amount of samples has to be processed or examined by means of one or a few standardized laboratory processes.

Additionally, laboratories or laboratory systems are known from the state of the art in which a plurality of different laboratory devices is used, each of which can be used in a more flexible manner for processing samples and performing laboratory processes by corresponding pre-settings, settings and/or configurations. However, several laboratory processes are usually required for a complete examination or analysis of a sample; accordingly, said laboratory processes have to be performed by different laboratory devices, considerable effort thus being required in order to transfer the samples to the corresponding laboratory devices. Another disadvantage is that the transfer of the samples to be processed or to be further processed to the laboratory devices and between the laboratory devices is usually performed by personnel, these activities thus being expensive and still error-prone. Furthermore, it is not easy to ensure that the sample processing is correctly and accurately recorded when a sample is conveyed or transported between the laboratory devices by human users or operators; however, this is of vital importance both for the significance of the result of the sample processing or sample analysis and for the increasingly important certification of laboratories and laboratory systems for certain activities or sample processing. Finally, another disadvantage is that, as a result of systemic bottlenecks or overcapacities which are not detectable or which are detected, the resources of the laboratory system can only be insufficiently used in a laboratory system which comprises a plurality of laboratory devices; on the one hand, this leads to an unnecessarily long processing time and, on the other hand, this increases the average costs of sample processing.

### SUMMARY OF THE INVENTION

Starting from the state of the art described above, the object of the present invention is to propose a laboratory system comprising at least partially networked laboratory devices for processing samples and a method for controlling a laboratory system comprising at least partially networked laboratory devices for processing samples in which a plurality of different samples can be subjected to an almost unlimited number of processing options or analyses/examination; at the same time, the resources of the laboratory system, in particular of the laboratory devices, are used in the best possible way.

With respect to the method for controlling a laboratory system comprising at least partially networked laboratory devices for processing samples by means of laboratory processes performed by the laboratory devices, said object is attained in that a process detection step is provided in which the samples to be processed and/or laboratory processes to be performed with the samples are detected via a detection unit, wherein a status determination step is also provided in which a response of the networked laboratory devices regarding the current and/or future state and/or the completion of sample processing or of a laboratory process of the laboratory devices is obtained, wherein a task update is also performed in which a task list, at least for the processing of specific samples by means of a specific laboratory device or a plurality of specific laboratory devices, is created or updated in a specific order by a task generation unit at least from the detected samples and/or laboratory processes and/or on the basis of the status of the laboratory devices, in particular in view of predefined prioritization rules and/or weighting factors; wherein, in a guidance step, guidance instructions are also generated and outputted by a guidance system on the basis of the current task list, wherein the guidance instructions at least indirectly cause the transfer of detected samples to at least one laboratory device and wherein, in a transport means control step, transport means control instructions are also generated by a transport means control system on the basis of guidance instructions and are in particular transmitted to at least one transport means configured as a UAV (Unmanned Aerial Vehicle), at least for the transport of detected samples.

The UAV or unmanned aerial vehicle can be a drone, a quadcopter, a multicopter or the like, for example. Consequently, any flying robot which can perform a function, such as a transport and/or an environment detection and/or a measurement process or the like, can be understood as a UAV according to the present invention. In particular, the term UAV shall also include unmanned, flying small or miniature robots, only a transport weight of a few grams has to be handled, especially for the transport of individual or several samples; as a result, correspondingly small unmanned aerial vehicles which are inexpensive to purchase and to operate can also be used in an advantageous manner in the system and method according to the invention.

Thus, the idea of the method according to the invention provides that all samples and the necessary sample processing on the basis of laboratory processes are recorded centrally and/or decentrally and are updated accordingly, wherein the respective state or the respective status of the laboratory devices provided for the processing is recorded or monitored as well to finally enable a fast sample transfer to or from the laboratory devices by means of transport means in the form of unmanned aerial vehicles (UAV), wherein the sample transfer is adapted to the current resources and tasks of the laboratory system and can be properly documented. Firstly, the effectiveness and the throughput of the laboratory system is significantly increased in this way. At the same time, sample traceability and sample processing documentation or analysis documentation are significantly improved and the overall quality management is thus significantly enriched. Finally, the unmanned aerial vehicles can be used to transport the samples to the respective laboratory devices in a safe, fast and reliable and fully traceable manner.

The networking of the laboratory devices can be realized via a server-client structure, for example. However, other network structures can also be used to network the laboratory devices with one another. Decentralized networking of the laboratory devices is also possible. Similarly, method steps, such as the process detection step, the status determination step, the task update step, the guidance step and the transport means control step, can be performed, taken or managed centrally or decentrally. For example, an operator input interface can be provided for the process detection step via the detection unit, the samples and the laboratory processes to be performed with the samples being detected by means of the operator input interface. The process detection step can also provide that the samples and/or the sample vessels obtain a corresponding marking or identification means. For example, optical identification means, such as barcodes or QR codes, can be used for this purpose. In the process detection step, known, predefined laboratory processes can be selected or new laboratory processes can be defined. It may also be possible to allow an import of laboratory processes defined elsewhere via corresponding networking with other data processing devices.

The status determination step needs a central or uniform component insofar that, if possible, the status determination step requests the status of all networked laboratory devices at a specific time and said state is thus reported back to the status determination step. However, the question of whether, following the generation of a corresponding request to all networked laboratory devices, the response of the networked laboratory devices is collected centrally at one point of the system or is immediately transmitted decentrally to different points of the system can be left open. However, it makes sense to receive and, where appropriate, store the response of the networked laboratory devices centrally at at least one point in the system. The status determination step can be performed via known means and methods for networking laboratory devices. For example, the laboratory devices can be indirectly or directly networked with one another in a wired or wireless manner via data processing means. In principle, different methods and means can be used and combined with one another for this purpose. For example, a wireless connection or networking by means of Wireless Local Area Networks (WLAN) or Bluetooth can take place in addition or as an alternative to a wired connection via Local Area Network, Ethernet or the like.

The task update step, like the status determination step, is a recursive step in the method for controlling the laboratory system according to the invention. In the task update step, the overall state of the laboratory system and of the samples detected in or for the laboratory system is first determined in the broadest sense and the state of the laboratory devices or the status of the laboratory devices is thus detected as well. On the basis of said overall state of the system based on the detected samples and/or laboratory processes and on the status of the laboratory devices, an optimization method is performed in which the detected samples and the associated laboratory processes are assigned to corresponding laboratory devices and to a corresponding order of laboratory devices. In principle, a plurality of known methods is available for the optimization process, wherein said method can be mapped or executed within the scope of algorithms, for example. For example, “cost optimization” can be performed, wherein so-called “costs” or “cost factors” are assigned to the samples, the transport routes, the waiting time of the samples, the laboratory processes, the laboratory devices and many other details of the laboratory system and the current minimum total cost of the system is then determined by means of minimization algorithms known per se, which in turn results in a corresponding assignment of samples and laboratory processes to laboratory devices and a corresponding order of laboratory devices. Many other approaches leading to a maximization or minimization and therefore to an effective distribution and processing of the samples are also known. In the above example, the so-called “costs” are not necessarily to be considered economic or monetary costs, but rather a measure of the effort involved in the sample processing. The current task list represents result of this optimization method in the course of the task update step; in the task list, a corresponding processing schedule or at least a current next processing step is allocated or assigned to the respective samples and to the laboratory processes to be performed with the samples or to be carried out on the samples, wherein the processing step generally refers to any activity performed with or on the samples. In particular, this includes the transfer of samples to laboratory devices, but also to other to other places such as waiting places, storage places, infeed and outfeed places and the like. However, another advantageous option is to record and, where appropriate, minimize the economic costs before, during and/or after the sample processing. This creates a particularly high level cost transparency.

In the course of the guidance step, a set of guidance instructions, or at least one guidance instruction, is generated and outputted by a guidance system on the basis of the current task list, to cause the corresponding guiding of samples or the at least indirect transfer of samples to at least one laboratory device. Thus, in the course of the guidance step, the guidance system performs the measures taken or theoretically calculated in the course of the task update step in order to increase the actual processing of the samples and therefore the efficiency of the laboratory system. The guidance instructions which are generated and outputted by the guidance system can, for example, comprise a combination of one or several samples, where appropriate with a current sample location and one or several target locations for the one or the plurality of samples. A single guidance instruction can be generated which contains all instructions. Alternatively, a plurality of guidance instructions can be generated which describe or determine the guiding of the samples in a grouped manner for groups of samples or even individually for individual samples. The output of the guidance instructions can be performed by means of data technology, for example.

In the transport means control step, transport means control instructions are generated by a transport means control system on the basis of the generated and outputted guidance instructions and are transmitted to at least one transport means configured as an unmanned aerial vehicle, at least for the transport of detected samples. The transport means control system may be configured to perform another optimization method in which an optimization with respect to the respective transport means control instruction and with respect to the at least one unmanned aerial vehicle is performed, the sample transport ultimately caused by the transport means control instructions thus also being performed with minimized effort or minimized “costs” and the resources of the system, in particular the unmanned aerial vehicles or the at least one unmanned aerial vehicle, thus being optimally used.

A first preferred embodiment of the method can also provide that that a transport means coordination step is performed in which new transport means control instructions are checked for state of no conflict on the basis of guidance instructions and already existing and/or still existing transport means control instructions and, in the case of conflict, are modified using other transport means control instructions by the guidance system. This ensures that transport means control instructions are generated, for example by a too high frequency actualization of the data relating to the system, in particular the status of the laboratory devices and the detected and/or partially processed and/or processed samples, and the transport means, i.e., the at least one unmanned aerial vehicle, are thus driven or controlled in a contradictory or ineffective manner. The transport means coordination unit can thus be used as a threshold value or hysteresis function to prevent contradictory transport means control instructions. Additionally, a broader conflict checking which takes into account not only logical conflicts but also spatial conflicts ensures collision prevention, in particular if more than one unmanned aerial vehicle is used as a transport means in the laboratory system. The transport means coordination step can also take into account types of conflicts. For example, the action of a person, preferably already the recognized or detected presence of the person and/or the position and/or movement of a person in space, in particular in the laboratory, can be considered a status change and a resulting conflict and in particular cause a possible safety shutdown. Accordingly, methods steps can be provided which recognize and/or detect the presence of persons, for example by means of an access control to the laboratory and/or by means of sensors.

Another preferred embodiment of the method can provide that a transport means localization step is performed within the scope of the method, in said transport means localization step, at least one current position of at least one transport means configured as an unmanned aerial vehicle and/or the guidance instructions already transmitted to the unmanned aerial vehicle are determined by the transport means control system. In this way, current collision monitoring or collision avoidance can be ensured in addition to basic collision prevention. Additionally, the optimization with respect to the sample transfer can be improved by determining the current position of the unmanned aerial vehicles because it is possible to determine the “best” drone for the transfer or the transport of one or several samples. Furthermore, the transport means localization step allows the establishment of the spatial relationship between the one or several transport means and the laboratory system at data level. To this end, the positions of the unmanned aerial vehicles are linked to digital geographic data of the laboratory. The geographic data of the laboratory show the topology of the laboratory environment, for example in a three-dimensional manner as a point cloud. Advantageously, the geographic data of the laboratory are regularly updated. For example, the geographic data of the laboratory can be read from barcodes, in particular 3D barcodes.

Another advantageous embodiment can provide that the method comprises a transport corridor assignment step in which a transport corridor for transport, in particular of detected samples, is assigned to a transport means configured as an unmanned aerial vehicle. In addition to a transport corridor assignment step, the method can also comprise other corridor assignment steps, for example a safety corridor assignment step, a movement corridor assignment step or a waiting corridor assignment step, each of which is assigned to at least one transport means configured as an unmanned aerial vehicle. This ensures the operational safety of the entire laboratory system, in particular if a plurality of unmanned aerial vehicles is used, because, depending on the situation, task or on another basis, corresponding stay and/or movement corridors are assigned to the transport means or unmanned aerial vehicles in the three-dimensional space of the laboratory system. The corridors can be partially spatially separated from one another. For example, the corridors can be separated from the other parts of the laboratory by intermediate ceilings or suspended ceilings of the laboratory, wherein corresponding entrances and exits to the corridors must, of course, be provided. Alternatively or additionally, the corridors can be realized or separated by nets or similar collection devices. If the corridors are not structurally or physically separated from one another, the system can be configured to dynamically change the corridors. For example, a corridor generation unit can be provided which generates, changes or deletes corridors in a corridor generation step, for example depending on the overall situation of the system. For example, the time and therefore the presence or absence of human personnel in the laboratory or in the laboratory system can be taken into account in order to generate, change or delete corresponding corridors on the part of the system and/or by the method. At night, for example, when no human operators or users of the laboratory cannot or may not be present in the laboratory system, a plurality of corridors, such as transport corridors or the like, can be defined and used or flown by the unmanned aerial vehicles, wherein said corridors cannot or are not to be provided for collision prevention or for collision avoidance when human operators or human personnel is/are present in the laboratory system.

Another alternative of the method provides a consumables demand determination step in which, depending on at least the process detection step, preferably also depending on the status determination step and/or the task update step, the demand for consumables is determined, preferably on the part of the laboratory devices, in particular being determined individually for the respective laboratory devices, and is taken into account in the task update step. This can be used for different advantageous embodiments of the system and of the method. Firstly, the consumables demand determination step can be used to determine or predict in advance which consumables run out in which laboratory device. This knowledge can in turn be taken into account in the task update step. At the same time, however, the consumables demand determination step and its results can be used to provide consumables for the laboratory devices at an early stage or at least on a timely basis in order to avoid or prevent bottlenecks in the processing of samples, in particular in the operation of the laboratory devices. Furthermore, the consumables demand determination step can be integrated into the method in such a manner that not only guidance instructions for the at least indirect transfer of detected samples are generated and outputted, but also that guidance instructions for the at least indirect transfer of required consumables are generated and outputted. A conventional output, for example in paper form, can provided, the output then being performed or processed by a human operator or laboratory personnel. However, depending on the consumable, in particular depending on the volume, the weight and, where appropriate, depending on a hazard class of the consumable, the method can also provide that not only guidance instructions are generated and outputted, but also that transport means control instructions are generated and transmitted to the unmanned aerial vehicle(s) in the course of the transport means control step in order to transport consumables to the laboratory devices. Die to the properties of the unmanned aerial vehicles, consumables which have a low weight and/or a low volume are particularly suitable for transport by the unmanned aerial vehicles.

According to another particularly preferred embodiment of the method, a waste determination step can also be provided in which, depending on the status determination step and/or depending on current or previous task lists, the waste generation, in particular for the respective laboratory device, is determined and is taken into account in the task update step. The waste determination step thus acts in a way that is comparable to the consumables demand determination step; however, this does not apply to consumables and their demand, but this applies to the waste generated or produced in the laboratory devices and its disposal or transfer. Accordingly, guidance instructions for human operators or guidance instructions for the transport means control step can also be generated and outputted in order to dispose of the waste of the laboratory devices either by human operators or by the transport means configured as unmanned aerial vehicles. In this process, the type of waste, the amount of waste, in particular the weight and the volume of waste, can also be taken into account or integrated into the generation of guidance instructions.

Another particularly preferred embodiment can provide that static and dynamic information on the respective laboratory device, in particular in addition to sample processing, particularly preferably information on planned maintenance on or conversion of the laboratory devices, are taken into account in the status determination step. Static information which can be taken into account include, for example, a device class or a device type. In addition to the maintenance on and conversion of the laboratory device, dynamic information also include other information, for example the date of the last calibration of the device and its components. This not only ensures that time and cost optimization of the sample processing takes place in the course of the method according to the invention, but also ensures that an optimal quality management takes place in which certain samples or certain types of sample processing, in particular laboratory processes, are performed exclusively by appropriately approved or intended laboratory devices.

As described in earlier sections, a significant advantage of the method according to the invention is the possibility to make sample tracking more effective and free from errors. To realize this possibility, an advantageous embodiment of the method can provide a sample tracking method by means of which, starting with the detection of the sample, the sample processing, in particular on the basis of guidance instructions and/or transport means control instructions and/or transport means identifiers and/or laboratory device identifiers, particularly preferably together with respective timestamps, is tracked and/or recorded, in particular stored in a protocol data base, until the processing is completed. The method therefore allows complete documentation of the development of each sample or of the processing of each sample in the system and the storage of the corresponding documentation for the purpose of analysis or quality management, in particular in a realization in which the transport means carry out the complete sample transport.

Another advantageous embodiment of the method can provide that the method comprises an optimization proposal method in which proposals to expand the system, in particular with respect to the addition of laboratory devices and/or unmanned aerial vehicles, are created and/or outputted, in particular on the basis of a statistical evaluation of current and/or previous task lists and/or guidance instructions. In other words, this means that the method comprises a partial method which automatically identifies the bottlenecks of the sample processing, wherein said identification is generated on the basis of the actual or previous sample processing and therefore individually for the respective laboratory and its tasks or focus. In addition to the consideration of data relating to the current or previous sample volume and its processing, a future sample volume and its processing may also be predicted in the course of the prediction method, for example on the basis of self-learning algorithms or neural networks, wherein the corresponding prediction is taken into account in the proposal or the proposals to expand the system within the scope of the optimization proposal method. The laboratory system can thus be adapted and optimized in a particularly advantageous manner with respect to the devices of the system, i.e., with respect to the hardware of the system, which, in turn, optimizes and/or shortens the sample treatment or sample processing.

For example, another exemplary embodiment of the method can provide that the method comprises a test planning step which is performed subsequently to the process detection step and in which different options for performing the sample processing are created and, in particular, outputted, wherein, preferably subsequently to a selection of an option, in particular by an operator, particularly preferably via an input, the selected option is transmitted to the task generation unit and serves as a basis for a task update step. In this way, the user can identify and select different possible sample processing alternatives on the basis of preferences, for example. For example, a situation may arise in which two or more alternative types of sample processing or realizations of sample processing are available, but in which the respective realizations would not be performed by means of fully equivalent, alternative laboratory devices, the user or operator thus having the chance to define preferences as to which laboratory devices are used. For example, shorter sample processing may be preferred if the sample analysis or sample processing is particularly urgent, even if the result thus loses a certain level of accuracy or reliability. On the other hand, in sample processing which places particular emphasis on the accuracy of the result, an option for sample processing can be selected which accepts a longer processing time, but which is processed exclusively via or by means of laboratory devices which meet high standards.

Another particularly preferred embodiment of the method can also provide that a result checking step is performed in which, after the completion of sample processing, a result, in particular at least one result value, is compared with a specified result, in particular at least one specified result value and/or an associated threshold value, and the task update step is performed in the case of a deviation and/or exceedance in order to create and/or update a task list repeating the sample processing, wherein other laboratory devices than for the already completed sample processing are preferably provided for the renewed sample processing. Particularly advantageously, this allows the elimination of systematic errors caused, in particular, by the laboratory devices in the sample processing. A particular advantage of this embodiment is that the initiation or re-initiation of a corresponding sample processing is performed autonomously or automatically by the system and the method. For this purpose, but also for similar or related purposes, reserve samples or verification samples may already be detected but not yet processed in the course of the sample detection; depending, on the result of the result checking step of the method, the new sample processing or the processing of the reserve sample can thus be initiated or performed in a fully automated manner without further interaction with a user or operator, for example in order to provide another sample. This measure can also significantly improve the quality management of the laboratory system, because a largely automated possibility to perform test or reference measurement is provided, wherein said possibility also tries to eliminate systemic errors or errors caused by the laboratory devices, because, in the generation of the task list, other laboratory devices than for the previously performed or already completed sample processing are preferably provided for the renewed sample processing.

In another particularly preferred embodiment of the method, a, preferably periodically performed, securing step can be provided in which at least one generated or updated task list is transmitted to a securing means, in particular to a securing means which is part of at least one unmanned aerial vehicle, and is in particular stored. The securing means serves as a backup for possible data loss on the part of the system or of a part of the system. In addition to the task list, other important information of the system and of the method for controlling the system can be transmitted to the securing means and can be stored there. For example, the samples intended for the processing and the associated laboratory processes can be saved periodically. The identified material requirements or the identified waste generation can also be transmitted to the securing means on the course of the securing step. Particularly preferably, each of the unmanned aerial vehicles can comprise a corresponding securing means. Accordingly, in the event of data loss or partial data loss, the unmanned aerial vehicle having the last or latest data backup in corresponding securing means could be determined as a first step by exchanging data between the unmanned aerial vehicles. Starting from said unmanned aerial vehicle or its securing means, data recovery and data dissemination to other instances of the system could then be initiated. In addition or as an alternative to the arrangement of the securing means in the unmanned aerial vehicle(s), the securing means may also be disposed on or linked to a data management device which is networked with the system, for example.

Another particularly advantageous embodiment of the method can also provide that access right management takes place in which, starting with the process detection and preferably up to a generation of a result of sample processing, information and data relating to the sample processing are subject to an, in particular hierarchical, preferably multi-stage, access restriction, in particular reading restriction and/or writing restriction, wherein said restriction can preferably be changed by an operator performing the process detection step before, during or after the sample processing. Firstly, this ensures that the sample processing itself, if this is not intended, is changed, suspended, stopped or otherwise manipulated by an operator or a person other than the person who has performed the process detection step. This is primarily used for quality assurance purposes. However, if desired, corresponding data of the sample processing can be released to one or several persons groups of persons, not only but especially subsequently to the completion of the sample processing. For example, it is possible that, already during the sample processing, a control or monitoring institution, whether in the form of a computer or of a person, is allowed access to the data already during and, where appropriate, can change data or even cancel the sample processing. But even after the sample processing, the data may be made available to a research group or a research network, for example for purposes of scientific cooperation, wherein differentiated reading authorizations and/or writing authorizations can be assigned again. Particularly advantageously, the samples processed by the system can thus be integrated into larger or more complex workflows in a particularly effective manner. For example, an optimal integration of the method for operating the laboratory system can thus be integrated into a hospital workflow or in processes of a research project; particularly advantageously, initially the respective user who performs or has performed the process detection step can determine when and for whom the data relating to the sample processing can be accessed and/or processed.

With respect to the laboratory system comprising at least partially networked laboratory devices for processing samples by means of laboratory processes performed by the laboratory devices, the object mentioned above is attained in that the laboratory system comprises a detection unit for detecting samples to be processed and/or laboratory processes to be performed with the samples, wherein the system also comprises a status determination unit which is at least indirectly connected to the laboratory devices and which is configured to request and/or receive and/or summarize responses from networked laboratory devices regarding the current and/or future status and/or the completion of sample processing by the laboratory devices, and wherein the laboratory system also comprises a task generation unit which is at least indirectly connected to at least the detection unit and the status determination unit and which creates and updates a task list, at least for the processing of specific samples by means of a specific laboratory device or a plurality of specific laboratory devices, in a specific order, at least from the detected samples and/or laboratory processes and/or on the basis of the status of the laboratory devices, in particular in view of predefined prioritization rules and/or weighting factors, and which stores said task list, preferably in a task database, wherein the laboratory system also comprises a guidance system which is at least indirectly connected to the task update unit and which is configured to generate and output guidance instructions on the basis of the current task list of the task data base, the guidance instructions at least indirectly causing the transfer of detected samples to at least one laboratory device, and wherein the system also comprises a transport means control system which is at least indirectly connected to the guidance system and which is configured to generate transport means control instructions on the basis of guidance instructions and to transmit said transport means control instructions to at least one transport means configured as an unmanned aerial vehicle (UAV), at least for the transport of detected samples.

In the context of the laboratory system, reference is to be made, in principle, to the above description of the method for its operation to avoid unnecessary repetition. With respect to the advantageous effects of the system components, reference can be made, if already performed to the corresponding methods or method steps which have already been described with regard to the method for controlling the laboratory system.

In the laboratory system according to the invention, too, the idea is to obtain as accurate and up-to-date an overview as possible of the overall state, i.e., of the detected samples and of the laboratory processes to be performed on the samples and of the laboratory devices, to optimize at least the transport of the samples between the laboratory devices and to and from the laboratory devices on this basis in such a manner that best use is made of the resources of the system and that the transport is simultaneously processed in a quick, safe and documentable manner. In this way, the system also allows the user to achieve a significant improvement in the sample traceability or in the sample documentation by accurately documenting and storing the transport processes performed by the transport means configured as unmanned aerial vehicles.

In addition to the laboratory devices and means for networking the laboratory devices, the transport means configured as unmanned aerial vehicles and the detection unit for detecting samples to be processed, the other units of the system can be configured, disposed and linked in different ways. For example, it can be provided that all components, in particular units are disposed and combined centrally in a data processing system. Alternatively, an arrangement which is distributed over a corresponding network can be provided. Finally, it is also possible to integrate the units, devices and systems into the transport means, i.e., into the unmanned aerial vehicles, wherein, on the one hand, a corresponding redundancy of the system components can be provided, but, on the other hand, individual system components can also be assigned to individual unmanned aerial vehicles and thus only provided in a single or singular manner. The laboratory devices are typically disposed in a laboratory or in a laboratory room. In principle, it is also possible that the laboratory extends over several rooms of a building. In principle, an extension over several floors of a building can also be provided.

The status determination unit, the task generation unit, the guidance system, the transport means control system and the corresponding connections between said system components can be configured as components of a corresponding data processing system. It is possible that different units and systems share certain devices or components of the data processing system. For example, it can be provided that different units use the same storage device, the same processing unit or the same memory. Alternatively, however, it can be provided that individual or all units and components of the system realize self-contained or individual data processing units.

An advantageous embodiment of the laboratory system can provide that the guidance system is configured to check new transport means control instructions for state of no conflict on the basis of guidance instructions and already generated and/or still existing transport means instructions and, in the case of conflict, to modify the new transport means control instructions by means of other transport means control instructions. To this end, the guidance system can be equipped with corresponding mechanisms which are able, for example, to identify the contradiction of transport means control instructions and/or which able to identify possible collisions between transport means on the basis of the current set of transport means instructions.

Another particularly preferred embodiment of the laboratory system can also provide that a transport means localization unit or a transport means localization system is provided which is configured to determine at least one current position of at least transport means configured as an unmanned aerial vehicle and/or the guidance instructions already transmitted to the unmanned aerial vehicle by the transport means control system. The transport means localization unit or the transport means localization system can have transponder which are assigned to the unmanned aerial vehicles. Moreover, the unit or the system can comprise a query or request device which is configured to establish a data connection to the transponders, where appropriate inly for a short period of time, and to induce the transponders to return corresponding position or localization data to the query or request device. In principle, known methods and devices can be used as positioning standards or as localization mechanism. For example, the transponders can determine the current position in space by means of a triangulation method. However, optical, in particular three-dimensional optical, methods can be used to localize the unmanned aerial vehicles in space. Firstly, it can be provided that the space itself or the laboratory system itself are monitored by means of corresponding optical detection units. Additionally, it can be provided that the unmanned aerial vehicles comprise optical detection units, in particular for the three-dimensional detection of the environment, by means of which the position or movement in space or in the laboratory system can be determined.

Another particularly advantageous embodiment of the laboratory system can provide that the laboratory system comprises a transport corridor assignment unit which is configured to assign a transport corridor for transport, in particular of detected samples, to a transport means configured as an unmanned aerial vehicle. As already described above with respect to the method for operating the laboratory system, other function corridors can also be generated, modified or assigned to the unmanned aerial vehicle for the respective purposes or in general by a corresponding corridor assignment unit. The implementation of the transport corridor assignment unit or of a comparable corridor assignment unit can be realized in such a manner that the transport means control instructions are specified or limited in such a manner that the unmanned aerial vehicles can solely use or fly in the correspondingly assigned corridor. If the transport means control instructions are less specific and, for example, specify only target point or waypoints and a target point, the transport corridor assignment unit can also be configured in such a manner that it is able to define limit values or interfaces or limit planes in space which are transmitted to the unmanned aerial vehicle and which are used to limit the movement of the unmanned aerial vehicle in space.

Another particularly advantageous embodiment of the laboratory system can provide that the laboratory system comprises a consumables demand determination unit which is configured to receive data from the detection unit, preferably also in interaction with the status determination unit and/or the task generation unit, and to determine the demand for consumables on the basis of said data, preferably on the part of the laboratory devices, in particular individually for the respective laboratory devices, and to transmit said demand to the task generation unit. The demand for or the consumption of consumables on the part of the laboratory devices or other system components can be actually measured or monitored by corresponding sensors or calculated or extrapolated on the basis of reports, in particular of status reports of the laboratory devices which are identified and received by the status determination unit. As already explained above, this ensures that the laboratory system can be operated with as little disruption or interruption as possible, because ideally a sufficient amount or quantity of consumables is available at any given time. The supply of the consumables can be performed by human operators, by the unmanned aerial vehicles or by other transport means, such as robots.

Another particularly advantageous embodiment can also provide that the laboratory system comprises a waste determination unit which is configured to receive data from the status determination unit and/or the task generation unit and to determine the waste generation, in particular for the respective laboratory device, on the basis of said data and to transmit said waste generation to the task generation unit. This can also ensure more effective operation of the laboratory system.

Another advantageous embodiment can also provide that the status determination unit is configured to receive and/or take into account static and dynamic information on the respective laboratory devices, in particular in addition to sample processing, in particular information on planned maintenance on or conversion of the laboratory device. The task generation unit can thus generate or update an optimized task list taking into account the corresponding downtimes of the respective laboratory devices or an at least slower throughput of the laboratory devices within a certain period of time in a particularly advantageous manner. This is another particularly advantageous way of achieving a significantly increased use efficiency of the laboratory system.

Another particularly preferred embodiment of the system can also provide that a sample tracking unit is provided which is configured to track and record, in particular to store in a protocol database, the sample processing starting with the detection of the sample until the completion of the processing, in particular on the basis of guidance instructions and/or transport means control instructions and/or transport means identifiers and/or laboratory device identifiers, particularly preferably together with respective timestamps. Thus, the sample tracking unit is a particularly advantageous further development of already known digital laboratory notebooks. This is because significant automatization with respect to the digital laboratory notebook can be achieved by the use of the unmanned aerial vehicles as transport means and by the corresponding monitorability or traceability of the transport means and therefore of the samples themselves; said automatization in turn leads to the elimination or at least minimization of errors, for example missing documentation, insufficient documentation or incorrect documentation. If, for example, the entire sample transport starting with the detection of the sample takes place via the transport means configured as unmanned aerial vehicles, the entire sample processing can be documented in a fully automatic manner and stored in a corresponding protocol database, for example. If necessary, it can be provided that not only the sample processing itself, but also corresponding processing results, measurement results or measurement values which are produced or arise in the course of the sample processing are stored in the protocol database together with the corresponding data relating to the course of the sample processing. Particularly advantageously, the networking between the laboratory devices and the laboratory system can also be used for this purpose, the corresponding data relating to a sample, both in terms of the sample processing and in terms of the results identified or generated by the laboratory devices, thus being collected and stored centrally or decentrally, for example in a network storage or in a cloud storage device.

Another particularly preferred embodiment of the laboratory system can provide that the laboratory system comprises an optimization proposal unit which is configured to create and/or output proposals to expand the system, in particular with respect to the addition of laboratory devices and/or transport means configured as unmanned aerial vehicles, in particular on the basis of a statistical evaluation of current and/or previous task lists and/or guidance instructions. This ensures that the laboratory system can constantly grow with the requirements of the laboratory system and can expand, wherein, in addition to a statistical evaluation of data relating to the past and the present, a prognosis or extrapolation for the future, for example on the basis of neural networks or machine learning, may be performed and integrated into the proposals of the optimization proposal unit.

Another particularly preferred embodiment of the laboratory system can comprise a test planning unit which is configured to create and, in particular, output different options for performing the sample processing by means of the system, wherein the selected option is transmitted to the task generation unit, preferably subsequently to a selection of an option, in particular via an input unit. In addition a particularly effective use of the capacities of the laboratory system, this also ensures that specific preferences of the user or operator, in particular of the operator who performs a sample detection, can be taken into account. For example, an operator can accept a longer sample processing or a longer total sample processing time if he/she wishes to use highly precise or highly accurate laboratory devices for the sample processing itself, said laboratory devices, however, either allowing a lower sample throughput or being used more frequently than less accurate laboratory devices. The test planning unit can be configured in such a manner that preferences or preference criteria are preset or can be defined manually. For example, preference criteria such as “fast”, “accurate” can be predefined. Moreover, a hierarchy of alternative laboratory devices can be defined within the scope of the definition of planning criteria, wherein the test planning unit then tries to realize the test planning by means of the preferred laboratory devices. This can also be used, for example, to meet the customer requirements or externally specified requirements of the laboratory system. Accordingly, it can be provided that the test planning unit and the user interact or communicate with one another via a corresponding user interface and create and select a preferred option for performing the sample processing as a result.

Another particularly preferred embodiment of the laboratory system can provide that the system comprises a result checking unit which is configured to compare a result, in particular at least one result value, with a specified result, in particular at least one specified result value and/or an associated threshold value, after the completion of sample processing and, in the case of a deviation and/or exceedance, to induce the task generation unit to create and/or update a task list repeating the sample processing, wherein other laboratory devices than for the already completed sample processing are preferably provided for the renewed sample processing. In addition to the sample transport carried out at least by the unmanned aerial vehicles, systemic errors in the sample processing can be further minimized or excluded by the result checking unit, the overall reliability of the results of the sample processing thus being significantly increasable.

According to another particularly preferred embodiment, the laboratory system can also comprise a securing means, wherein the securing means is particularly preferably part of at least one transport means configured as an unmanned aerial vehicle and wherein the securing means is configured to, preferably periodically, receive and/or to store generated and updated task lists. In this way, corresponding security mechanisms are introduced which result in the prevention of a failure of the laboratory system, for example on the basis of at least partial data loss. Likewise, another advantageous embodiment of the laboratory system can provide that a storage device and/or storage structure which is provided with an access right management is provided which is configured to collect information and data relating to a sample processing starting with the sample and/or process detection and preferably until a result of the sample processing is generated and which is configured subject said information and data to an, in particular hierarchical, access restriction, in particular reading restriction and/or writing restriction, wherein said restriction can preferably be changed before, during or after the sample processing by an operator who performs the sample and/or process detection step. This allows a particularly preferable integration of the laboratory system into a larger context, for example into a medical institute, into a scientific institute, a scientific research community or a hospital or comparable institution, because, in addition to the collection of data relating to a sample processing, the accessibility and distribution and the processing of said data can be realized in a particularly simple and at the same time secure manner, because the corresponding release and/or the granting of corresponding rights to process the data is subject to corresponding access restriction which can, however, be changed or removed by appropriately authorized users or operators.

### BRIEF DESCRIPTION OF THE DRAWINGS

Further advantages, features and details of the invention are apparent from the following description of preferred exemplary embodiments and from the drawings; in the drawings,

FIG. 1 shows a schematized sequence diagram of a method according to the invention according to a first embodiment;

FIG. 2 shows a schematized illustration of a system according to a first embodiment.

### DETAILED DESCRIPTION

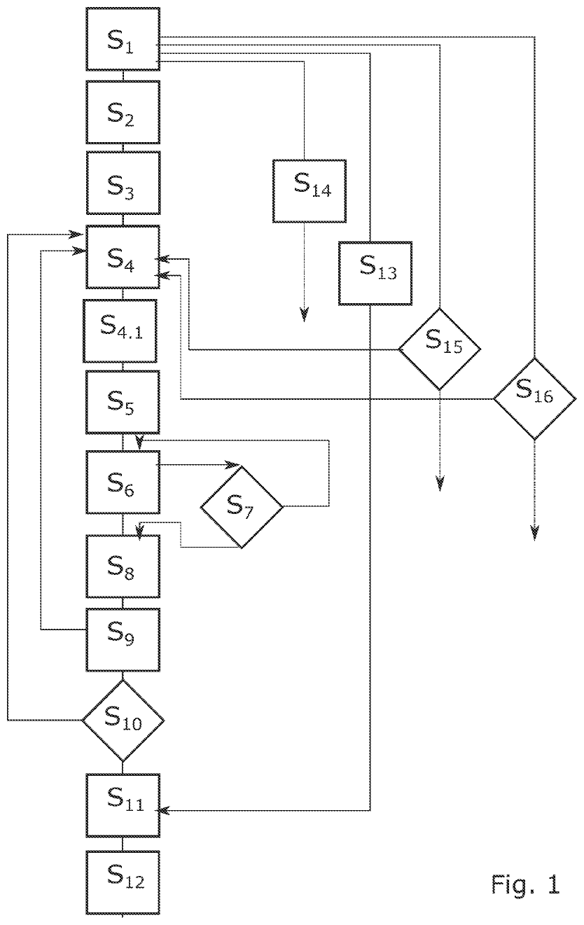

FIG. 1 shows a schematized sequence diagram of a method according to the invention according to a first embodiment.

In a first method step, a process detection step S1 is performed in which samples to be processed and/or laboratory processes to be performed with the samples are detected via a detection unit. The process detection or process detection step S1 can be performed manually as well as partially or fully automated. For example, it can be provided that an operator detects individual or a plurality of samples and either determines the associated laboratory processes himself or imports them from another point which is networked with the detection unit. The process detection step can also provide that the sample or the samples are marked accordingly, so that the sample can be assigned to the operations of the process detection step. For example, optical markings can be made on the sample vessel.

In a second method step, a test planning can be performed within the scope of a test planning step S2 subsequently to the process detection. Alternatively, test planning step S2 can be performed subsequently to a status determination step S3. However, since status determination step S3 is usually repeated on a regular basis or is performed in a recursive manner, the decision whether test planning step S2 is already performed subsequently to process detection step S1 or only subsequently to status determination step S3 can also be made dependent on the age or on the time of the last performance of the status determination step. In test planning step S2, different options for performing the sample processing are created and, in particular, outputted by means of the system, wherein, preferably subsequently to a selection of an option, for example via an input of a user, the selected option is transmitted to the task generation unit and serves as a basis for a task update step. Accordingly, the available laboratory devices, their capacities or throughputs, their classification or other properties can be taken into account in test planning step S2. Additionally, predefined or personally defined test planning options or test planning criteria, such as fastest test execution or fastest sample processing, can be selected and/or taken into account in the test planning or in test planning step S2.

In the example of the process sequence of FIG. 1, status determination step S3 is performed subsequently to test planning step S2; in status determination step S3, a response of networked laboratory devices regarding the current and/or future state and/or the completion of sample processing is obtained by the laboratory devices. To this end, a status request may be sent to the individual laboratory devices by the system or a central or decentral point of the system; the individual laboratory then send back or report a corresponding response, for example transmitted in a standard protocol, which can then be further processed by the system, in particular included in task update step S4.

In task update step S4, a task list, at least for the processing of specific samples by means of a specific laboratory device or a plurality of specific laboratory devices, is created or updated in a specific order by a task generation unit at least from the detected samples and/or the detected laboratory processes for the samples and at least on the basis of the status of the individual laboratory devices, in particular in view of predefined prioritization rules and/or weighting factors. In the example of FIG. 1, the result of test planning step S2 can also be taken into account in the task updating or task update step S4. The task list created or updated in task update step S4 thus includes a list of tasks for each sample which indicates which laboratory devices are required in which order to process said sample. Moreover, since the task list also takes into account status determination step S3, the remaining processing or the laboratory devices still to be run through can be distinguished from the laboratory devices already run through in the task list in the case of a partially processed sample or a sample which is already being processed and the task list can either be updated accordingly or at least marked in such a manner that it allows an up-to-date image or up-to-date representation of the processing states of the individual samples, at least from the sample processing sequence.

In a subsequent method step S4.1, for example, a securing step can be performed in which at least one created or updated task list of task update step S4 is transmitted to a securing means, in particular a securing means which is part of at least one unmanned aerial vehicle, and is in particular stored. This ensures that, in the case of partial or complete data loss, the last known situation of all samples in their processing can be reconstructed and the operation of the system or the method for operating the system can be resumed without complications if possible.

In the following guidance step S5, at least one guidance instruction is generated and outputted on the basis of the current task list, the guidance instructions at least indirectly causing the transfer of detected samples to at least one laboratory device. In principle, the generation and output of the guidance instructions is not limited to one guidance instruction for one machine or one technical device. Guidance instructions to human operators or users of the system can also be generated and outputted in the course of the guidance step, for example in the form of screen displays or other outputs.

In a subsequent method step, a transport means control step S6 can be performed in which transport means control instructions are generated by a transport means control system on the basis of guidance instructions and are transmitted to at least one transport means configured as an unmanned aerial vehicle, at least for the transport of detected samples. The transport means control instructions can comprise waypoints and target points of a transport means control, for example. Transport means control step S6 be followed recursively by a transport means coordination step S7 in which new transport means control instructions are checked for state of no conflict with other transport means control instructions on the basis of guidance instructions and already and/or still existing transport means control instructions and, in the case of conflict, are modified using other transport means control instructions in order to prevent conflicts, in particular logical conflicts as well as conflicts which have a collision potential of transport means.

In the subsequent method step, a transport corridor assignment step S8 or another corridor assignment step can be performed in which a transport corridor or another corridor is assigned to a transport means, i.e., to a transport means configured as an unmanned aerial vehicle.

In the following transport step S9, the sample is then transferred from a first place, for example a place of the detection, to a second place, for example a laboratory device for performing a laboratory process. Following transport step S9, described method steps S4 to S9 can be run through or repeated following the respective the respective sample processing or performance of a laboratory process by the respective laboratory device until the respective sample has reached the end of the sample processing or the completion of the last laboratory process.

In this respect, it is worth mentioning that the sequence diagram of FIG. 1 only describes the way or the method regarding a single sample and that, of course, one or several other appropriate processes can run in parallel, where appropriate with a time lag, in addition to the sequence diagram of FIG. 1, said processes leading to the fact that the individual samples reach the end of the sample processing. Accordingly, this method or these method parts does not necessarily require that all transport steps S9 are necessarily performed by a transport means configured as an unmanned aerial vehicle. However, any transport of a sample is particularly preferably carried out by a corresponding unmanned aerial vehicle.

In a result checking step S10 which extends to the last sample processing or last transport step S9, for example from a last laboratory device to a storage or outward transfer point, a result, in particular at least one result value, can be compared with a specified result, in particular at least one specified result value and/or an associated threshold value, after the completion of sample processing and task update step S4 is performed in the case of a deviation and/or exceedance in order to create and/or update a task list repeating the sample processing, wherein other laboratory devices than for the already completed sample processing are preferably provided for the renewed sample processing.

Following result checking step S10, a storage of the results in the course of a storage step S11 can be provided. However, storage step S11 can also be performed successively in parallel with the respective steps of the sample processing to ensure that data or results are not already lost during the sample processing. Following storage step S11, but also already in parallel with the sample processing, where applicable, a publication of the corresponding results of the sample processing can be made in a publication step S12 or a step for access right management, the information and data relating to the results of the sample processing being released according to a hierarchical, preferably multi-stage, access restriction, in particular reading restriction and/or writing restriction. Said release is preferably carried out by the operator who performs the process detection step to release said information and data, for example to a working group, an affiliated hospital or a research community.

Alternatively, publication step S12 can already be performed at another time. Moreover, it can be provided that publication steps S12 are provided at different points to publish parts of the information and data, to change or undo publications of the information and data or merely to modify the level of publication, i.e., the stages of the access restriction.

In addition to the described method steps S1 to S12, further method steps can be performed in parallel with the method steps, wherein a corresponding interaction with the method steps described above can partially take place. For example, in the method step, a sample tracking method S13 can be performed by means of which, starting with the detection of the sample, the sample processing, in particular on the basis of guidance instructions and/or transport means control instructions and/or transport means identifiers and/or laboratory device identifiers, particularly preferably together with respective timestamps, is tracked and/or recorded, in particular stored in a protocol database, until the processing is completed. Accordingly, the embodiment of FIG. 1 provides that the results of the sample processing method are merged with other storage of the information and data relating to the sample processing in method step S11. Furthermore, in the course the course of a recursively performed determination step S15 and a consumables demand determination step, both of which are preferably recursively performed during steps S1 to S12 on a recurring basis, the demand for consumables and the waste generation, preferably at the respective laboratory devices, can be determined and also periodically or recursively taken into account in the system or in the method in such a manner that the demand for consumables and the waste is taken into account in task update step S4.

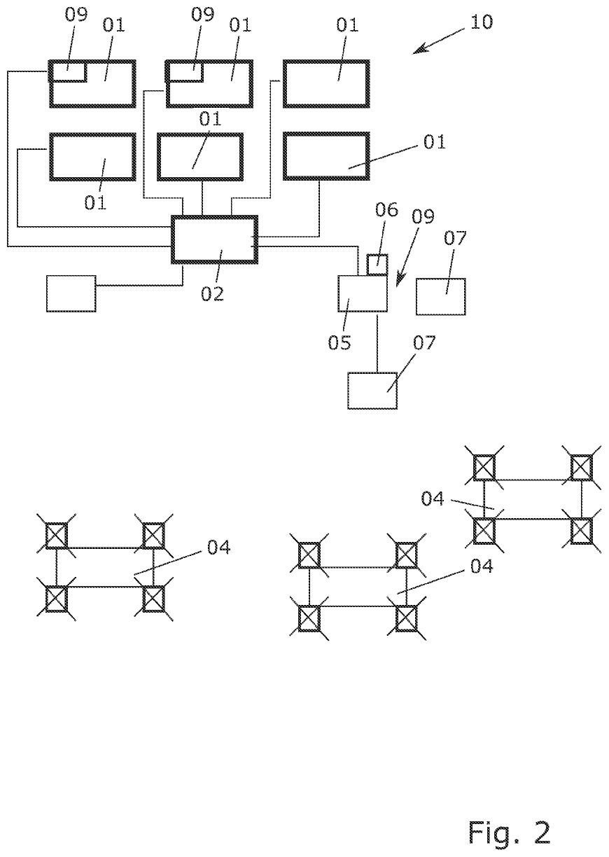

FIG. 2 shows a schematized illustration of a system 10 according to a first embodiment. The system comprises a plurality of laboratory devices 01 which are networked with a central data processing system 02 via corresponding connections 03 in the example of FIG. 2. Additionally, system 10 comprises a plurality of transport means configured as unmanned aerial vehicles 04. Central data processing system 02 is connected to a detection unit 05 which comprises an input and/or output interface 06 and which is also linked to a data processing device 07 which is configured to define laboratory processes.

For example, the status determination unit, the task generation unit, the guidance system and the transport means control system can be disposed in the data processing system shown as central data processing system 05 in FIG. 2. However, the corresponding units and system can also be disposed or integrated elsewhere for example on the side of unmanned aerial vehicles 04. Both central data processing system 02 and unmanned aerial vehicles 04 can be provided with components of a transport means localization unit which are used to determine the at least current position of unmanned aerial vehicles 04 and/or guidance instructions already transmitted to unmanned aerial vehicles 04.

The transfer of samples 07 from a point of detection 08 to laboratory devices 01 can be carried out by means of unmanned aerial vehicles 04. The transfer of samples 07 between laboratory devices 01 can also be carried out by the transport means configured as unmanned aerial vehicles 04. It can be provided that laboratory devices 01 and other central points for the arrangement, storage, transfer or stay of samples 07 are provided with landing sites 09 for unmanned aerial vehicles 04, wherein landing sites 09 are preferably realized in such a manner that an electrical contact is automatically established between a contact point of landing site 09 and a contact point of unmanned aerial vehicle 04 when unmanned aerial vehicles 04 land, an energy storage 11 of unmanned aerial vehicle 04 thus being chargeable when unmanned aerial vehicle 04 lies on or sits on landing site 09. Preferably, the energy supply of unmanned aerial vehicles 04 can thus be maintained for a long, preferably unlimited, time.

Optical detection units, for example 2D or 3D cameras, which are part of unmanned aerial vehicles 04 can be used for landing unmanned aerial vehicles 04, in particular for precise landing in order to contact the contact points.

### REFERENCE SIGNS

01 laboratory device
02 data processing system
03 connection
04 aerial vehicle
05 detection unit
06 output interface
07 data processing device
08 point of detection
09 landing sites
10 system
11 energy storage
S1 process detection step
S2 test planning step
S3 status determination step
S4 task update step
S4.1 subsequent method step
S5 guidance step
S6 transport means control step
S7 transport means coordination step
S8 assignment step
S9 transport step
S10 result checking step
S11 storage step
S12 publication step
S13 sample tracking method
S16 consumables demand determination step

1. A method for controlling a laboratory system comprising at least partially networked laboratory devices for processing samples by means of laboratory processes performed by the laboratory devices, the method comprising
a process detection step (S1) in which samples to be processed and/or laboratory processes to be performed with the samples are detected via a detection unit (05);
a status determination step (S3) in which a response of networked laboratory devices regarding the current and/or future state and/or the completion of sample processing is obtained by the laboratory devices;
a task update step (S4) in which a task list, at least for the processing of specific samples by means of a specific laboratory device or a plurality of specific laboratory devices, is created or updated in a specific order by a task generation unit at least from the detected samples and/or laboratory processes and/or on the basis of the status of the laboratory devices;
a guidance step (S5) in which guidance instructions are generated and outputted by a guidance system on the basis of the current task list, the guidance instructions at least indirectly causing the transfer of detected samples to at least one laboratory device; and
a transport means control step (S6) in which transport means control instructions are generated by a transport means control system on the basis of guidance instructions and are transmitted to at least one transport means configured as a UAV (unmanned aerial vehicle (04)), at least for the transport of detected samples.

2. The method according to claim 1, further comprising a transport means coordination step (S7) in which new transport means control instructions are checked for state of no conflict on the basis of guidance instructions and already and/or still existing transport means control instructions and, in the case of conflict, are modified using other transport means control instructions by the guidance system.

3. The method according to claim 2, further comprising a transport means localization step in which at least one current position of at least one transport means configured as a UAV and/or the guidance instructions already transmitted to the UAV are determined by the transport means control system.

4. The method according to any claim 1, further comprising a transport corridor assignment step in which a transport corridor for transport is assigned to a transport means configured as a UAV.

5. The method according to claim 1, further comprising a consumables demand determination step in which, depending on at least the process detection step (S1), and is taken into account in the task update step (S4).

6. The method according to claim 1, further comprising a waste determination step in which, depending on the status determination step (S3) and/or depending on current or previous task lists, the waste generation is determined and is taken into account in the task update step (S4).

7. The method according to claim 1, wherein static and dynamic information on the respective laboratory devices, are taken into account in the status determination step (S3).

8. The method according to claim 1, further comprising a sample tracking method (S13) by means of which, starting with the detection of the sample, the sample processing is tracked and/or recorded until the processing is completed.

9. The method according to claim 1, further comprising an optimization proposal method in which proposals to expand the system (10) are created and/or outputted.

10. The method according to claim 1, further comprising a test planning step (S2) which is performed subsequently to the process detection step (S1) and/or the status determination step (S3) and in which different options for performing the sample processing are created and outputted by means of the system (10), wherein, subsequently to a selection of an option via an input, the selected option is transmitted to the task generation unit and serves as a basis for a task update step (S4).

11. The method according to claim 1, further comprising a result checking step (S10) in which, after the completion of sample processing, a result is compared with a specified result, and/or an associated threshold value, and the task update step (S4) is performed in the case of a deviation and/or exceedance in order to create and/or update a task list repeating the sample processing, wherein other laboratory devices than for the already completed sample processing are preferably provided for the renewed sample processing.

12. The method according to claim 1, further comprising a securing step, in which at least one generated or updated task list is transmitted to a securing means.

13. The method according to by claim 1, further comprising access right management in which, starting with the process detection and up to a generation of a result of sample processing, information and data relating to the sample processing are subject to an hierarchical, multi-stage, access restriction, wherein said restriction can be changed by an operator performing the process detection step (S1) before, during or after the sample processing.

14. A laboratory system comprising at least partially networked laboratory devices for processing samples by means of laboratory processes performed by the laboratory devices, the laboratory system comprising
a detection unit (05) for detecting samples to be processed and/or laboratory processes to be performed with the samples a status determination unit (S3) which is at least indirectly connected to the laboratory devices and which is configured to request and/or receive and/or summarize responses from networked laboratory devices regarding the current and/or future status and/or the completion of sample processing by the laboratory devices;
a task generation unit which is at least indirectly connected to at least the detection unit (05) and the status determination unit (S3) and which creates and updates a task list, at least for the processing of specific samples by means of a specific laboratory device or a plurality of specific laboratory devices, in a specific order, at least from the detected samples and/or laboratory processes and/or on the basis of the status of the laboratory devices, and which stores said task list in a task database;
a guidance system which is at least indirectly connected to the task update unit and which is configured to generate and output guidance instructions on the basis of the current task list, the guidance instructions at least indirectly causing the transfer of detected samples to at least one laboratory device; and
a transport means control system which is at least indirectly connected to the guidance system and which is configured to generate transport means control instructions on the basis of guidance instructions and to transmit said transport means control instructions to at least one transport means configured as a UAV, at least for the transport of detected samples.

15. The laboratory system according to claim 14, wherein the guidance system is configured to check new transport means control instructions for state of no conflict on the basis of guidance instructions and already generated and/or still existing transport means control instructions and, in the case of conflict, to modify the new transport means control instructions using other transport means control instructions.

16. The laboratory system according to claim 14, further comprising a transport means localization unit which is configured to determine at least one current position of at least one transport means configured as a UAV and/or the guidance instructions already transmitted to the UAV by the transport means control system.

17. The laboratory system according to claim 14, further comprising a transport corridor assignment unit which is configured to assign a transport corridor for transport of detected samples to a transport means configured as a UAV.

18. The laboratory system according to by claim 14, further comprising a consumables demand determination unit which is configured to receive data from the detection unit (05), and to determine the demand for consumables on the basis of said data, and to transmit said demand to the task generation unit.

19. The laboratory system according to by claim 14, further comprising a waste determination unit which is configured to receive data from the status determination unit (S3) and/or the task generation unit and to determine the waste generation, on the basis of said data and to transmit said waste generation to the task generation unit.

20. The laboratory system according to claim 14, wherein the status determination unit (S3) is configured to receive and/or take into account static and dynamic information on the respective laboratory devices.

21. The laboratory system according to claim 14, further comprising a sample tracking unit which is configured to track and record, the sample processing starting with the detection of the sample until the completion of the processing.

22. The laboratory system according to claim 14, further comprising an optimization proposal unit which is configured to create and/or output proposals to expand the system (10).

23. The laboratory system according to claim 14, further comprising a test planning unit which is configured to create and output different options for performing the sample processing by means of the system (10), wherein the selected option is transmitted to the task generation unit, subsequently to a selection of an option via an input unit.

24. The laboratory system according to claim 14, further comprising a result checking unit which is configured to compare a result, with a specified result, after the completion of sample processing and, in the case of a deviation and/or exceedance, to induce the task generation unit to create and/or update a task list repeating the sample processing, wherein other laboratory devices are provided for the new sample processing than for the already completed sample processing.

25. The laboratory system according to claim 14, further comprising securing means, being configured to periodically receive and/or to store generated or updated task lists.

26. The laboratory system according to by claim 14, further comprising a storage device and/or storage structure which is provided with an access right management, the storage device and/or storage structure being a cloud storage which has areas with restricted areas and which is configured to collect information and data relating to a sample processing starting with the process detection and preferably until a result of the sample processing is generated and is configured to subject said information and data to hierarchical, access restriction wherein said restriction can be changed before, during or after the sample processing by an operator who performs the process detection step (S1).
